(19) United States
(12) Patent Application Publication
(10) Pub. No.: US 2010/0310305 A1
(43) Pub. Date: Dec. 9, 2010

(54) Spherical joint with internal brake

(76) Inventor: Samir Mekid, Dhahran (SA)

Correspondence Address: LITMAN LAW OFFICES, LTD., PATENT LAW BUILDING, 8955 CENTER STREET, MANASSAS, VA, 20110, US

(21) Appl. No.: 12/457,382

(22) Filed: Jun. 9, 2009

(51) Int. Cl. F16D 1/12

(52) U.S. Cl. 403/104

(57) ABSTRACT

The spherical joint with internal brake has a controlled actuator that selectively brakes relative motion between interior members and an outer shell of the spherical ball joint. A shaft extending from the internal members can be stopped at any rotational position relative to the shell. The internal members may include a central spherical sectioned member sandwiched by a pair of symmetrically opposed peripheral spherical sectioned members, which selectively act as brakes when an actuator in the central member is energized. The energized actuator has a dual piston that pushes outwardly lo on the pair of opposed peripheral segments, which increases friction between the peripheral segments and an interior wall of the spherical shell to brake the system. The shaft extends from the central spherical sectioned member through an aperture in the shell. The size of the shell aperture determines the range of rotational motion of the shaft.

### BACKGROUND OF THE INVENTION

1. Field of the Invention

The present invention relates to mechanical couplings, and particularly to a spherical joint having an internal brake.

2. Description of the Related Art

Numerous ball and socket joints having manual joint locking mechanisms exist. Such mechanisms are usually very complex and due to the manual locking are not suitable for robotic or parallel kinematic machine operations. Even lockable joint devices linked to hydraulic systems may not be suitable for robotic applications, or the like. Moreover, ball joints with detent stopping action do not lock to an arbitrarily desired position, and therefore are not precise enough for robotic machine applications. It would be very desirable to overcome the aforementioned problems caused by the use of existing ball joint mechanisms.

Thus, a spherical joint with internal brake solving the aforementioned problems is desired.

### SUMMARY OF THE INVENTION

The spherical joint with internal brake has a controlled internal actuator that selectively brakes relative motion between internal members and an outer shell of the spherical ball joint. A shaft extending from the internal members can be stopped at any rotational position relative to the shell. The internal members include a central spherical sectioned member sandwiched by a pair of symmetrically opposed peripheral spherical sectioned members, which selectively act as brakes when an actuator in the central member is energized. The energized actuator has a dual piston that pushes outwardly on the pair of opposed peripheral segments, which thereby increases friction between the peripheral segments and an interior wall of the spherical shell to brake the system. The shaft extends from the central spherical sectioned member through an aperture in the shell. The size of the shell aperture determines the range of rotational motion of the shaft.

These and other features of the present invention will become readily apparent upon further review of the following specification and drawings.

### BRIEF DESCRIPTION OF THE DRAWINGS

FIG. 1 is a perspective view of a spherical joint with internal brake according to the present invention.

FIG. 2 is a side view in section of a spherical joint with internal brake according to the present invention, showing a first configuration of the joint in a normal position.

FIG. 3 is a side view in section a spherical joint with internal brake according to the present invention, showing a second configuration of the joint in an inclined position.

Similar reference characters denote corresponding features consistently throughout the attached drawings.

### DETAILED DESCRIPTION OF THE PREFERRED EMBODIMENTS

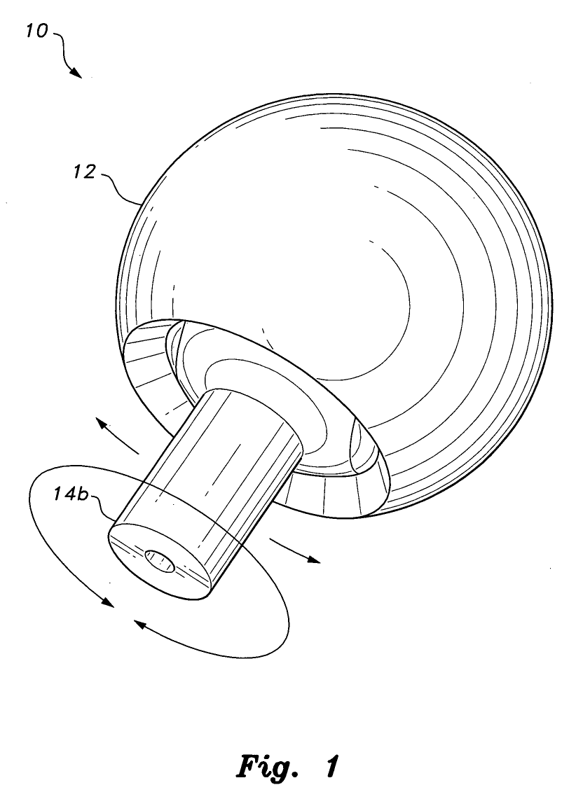

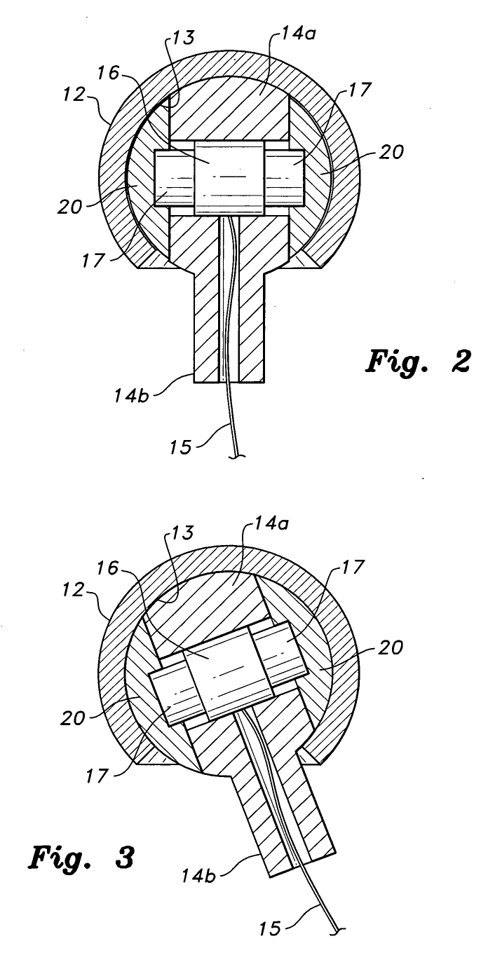

As shown in FIGS. 1-3, the spherical joint with internal brake, designated generally as 10 in the drawings, is a ball joint having a controlled internal actuator 16 that selectively locks a shaft 14b extending from a central spherical sectioned member 14a of the spherical ball joint 10 to any position within an engineered range of rotation. This type of joint finds utility in the field of robotics, parallel kinematic machines, and the like. Moreover, the joint 10 may be utilized in positioning devices, MEMS devices, micro-machines, and optical systems.

The spherical joint 10 is extremely important to unlock and enlarge the workspace and improve the dexterity of robots for many applications.

The joint 10 includes the outer retainer shell 12, which can be mounted on a fixed or a movable element. The spherical joint 10 allows relative spherical motion between outer shell 12 and interior components 14a, 20 of the joint 10. The spherical motion is limited by the size of the aperture in the spherical shell 12, the maximum range of motion being achieved when the aperture size is equal to the circumference of the external, spherical shell 12.

The internal portion of the spherical joint 10 includes peripheral spherical sections 20, which sandwich the central spherical section 14a to form an internal sphere inside of outer spherical shell 12 and in close proximity to the internal wall 13 of the outer spherical shell 12. A piezoelectric or electromagnetic actuator 16 having a dual piston 17 is held by the central spherical section 14a. The dual piston 17 has ends that are attached to the peripheral spherical sections 20.

Responsive to control signals received via a control line 15, the actuator 16 causes outward radial mechanical displacement of the dual piston 17, the mechanical displacement applying an outward radial force that pushes the peripheral sections 20 into frictional contact with the inner wall 13 of the outer spherical shell 12, thereby braking motion of the shaft 14b. Braking and release control commands via control line 15 may be sent by a proportional-integral-derivative (PID) controller, which is external to the joint 10. Alternatively, the braking and release control signals may originate from a controller internal to and operably connected to the spherical joint 10.

The internal spherical components 14a and 20 have smooth surfaces in full contact with the inner wall of shell 12, thereby permitting smooth spherical motion and motion locking at any position within the area of possible rotational motion. The spherical motion obtained from the spherical joint 10 has a precision motion quality.

The design principle allows precision spherical motion with controlled braking and locking at any position. The range of motion will be limited by the aperture size of the spherical retainer shell 12, which preferably is equal to or less than the circumference of the spherical retainer shell 12.

In a passive motion, the sphere can rotate to a desired position at which the piezoelectric/solenoid actuator 16 is activated, forcing the two opposite portions 20 to move outwardly to lock the joint at the desired position in a smooth manner.

It is to be understood that the present invention is not limited to the embodiment described above, but encompasses any and all embodiments within the scope of the following claims.

I claim:

1. A spherical joint with internal brake, comprising:
an outer spherical retaining shell having an outer wall and an internal wall, the retaining shell defining an aperture;
first and second internal spherical sectioned members disposed inside the outer retaining shell, the sectioned members being in contact with the internal wall of the outer retaining shell;
an actuator having a dual piston, the piston having opposed external ends, the external ends of the dual piston being attached to the first and second internal spherical sectioned members, respectively;
a third internal spherical sectioned member attached to the actuator;
an elongate member attached to the third internal spherical sectioned member, the elongate member extending through the shell aperture;
a control line operably connected to the actuator, the control line being adapted for relaying braking and release commands from a controller, the actuator responsively varying friction between the first and second spherical sections and the internal wall of the spherical retaining shell, thereby selectively braking and alternately allowing rotational motion of the internal spherical sections and the elongate member relative to the outer spherical retaining shell.

2. The spherical joint according to claim 1, further comprising means for positioning the internal spherical sectioned members and the extending elongate member at any position within a predetermined range of rotational motion with respect to the outer retaining shell.

3. The spherical joint according to claim 2, wherein the positioning means comprises an external PID controller connected to said control line.

4. The spherical joint according to claim 2, further comprising means or accepting actuator force magnitude commands from an external controller operably connected to the joint.

5. The spherical joint with internal brake according to claim 2, further comprising means for accepting actuator force magnitude commands from an internal controller operably connected to the joint.

6. The spherical joint with internal brake according to claim 1, wherein the actuator is piezoelectric.

7. The spherical joint with internal brake according to claim 1, wherein the actuator is electromagnetic.

8. A spherical joint with internal brake, comprising:
an outer spherical retaining shell having an outer wall and an internal wall, the retaining shell defining an aperture;
first and second internal spherical sectioned members disposed inside the outer shell, the sectioned members being in contact with the internal wall of the outer retaining shell;
an actuator having a dual piston, the piston having opposed external ends, the external ends of the dual piston being attached to the first and second internal spherical sectioned members, respectively;
an elongate member attached to the actuator and extending through the shell aperture; and
a control line operably connected to the actuator, the control line being adapted for relaying braking and release commands from a controller, the actuator responsively varying friction between the first and second spherical sections and the internal wall of the spherical retaining shell, thereby braking and alternately allowing rotational motion of the internal spherical sections and elongate member relative to the outer spherical retaining shell.

9. The spherical joint with internal brake according to claim 8, further comprising means for positioning the internal spherical sectioned members and extending the elongate member at any position within a predetermined range of rotational motion with respect to the outer retaining shell.

10. The spherical joint with internal brake according to claim 9, wherein the positioning means comprises an external PID controller connected to said control line.

11. The spherical joint with internal brake according to claim 9, further comprising means for accepting actuator force magnitude commands from an external controller operably connected to the joint.

12. The spherical joint with internal brake according to claim 9, further comprising means for accepting actuator force magnitude commands from an internal controller operably connected to the joint.

13. The spherical joint with internal brake according to claim 8, wherein the actuator is piezoelectric.

14. The spherical joint with internal brake according to claim 8, wherein the actuator is electromagnetic.
